(19) United States
(12) Patent Application Publication
(10) Pub. No.: US 2026/0126967 A1
(43) Pub. Date: May 7, 2026

(54) TECHNIQUES FOR REVISING USER INTERAFACES ASSISTED BY GENERATIVE PRE-TRAINED TRANSFORMER CODE GENERATOR

(71) Applicant: SAP SE, Walldorf (DE)

(72) Inventor: Evan Ireland, Waikanae (NZ)

(21) Appl. No.: 18/937,607

(22) Filed: Nov. 5, 2024

(51) Int. Cl. G06F 8/36; G06F 16/21

(52) U.S. Cl. CPC G06F 8/36; G06F 16/211

(57) ABSTRACT

In some implementations, the techniques may include accessing a view definition for each entity type in a data file, accessing a view schema file associated with the accessed view definition, and receiving a first input prompt to modify a structure of the data file. The techniques may include generating a method request to a generative pre-trained transformer, transmitting the method request, and receiving artificial function calls from the generative pre-trained transformer to modify the data file, displaying a plain language description of the function calls, and receiving a second input confirming modifications of the structure of the data file according to the plain language description of the function calls. The techniques may include modifying the structure of the data file using the function calls, generating code for an application using one or more templates using the modified data file, and storing the generated code for the application.

### BACKGROUND

Software applications have the capability to generate other software applications up to and including the generation of the specific program code for those applications. However, many of these applications that can be developed using these developer tools produce user interfaces that are not initiative to a user and are not organized and ordered in a way that is helpful to a user. The user interfaces for these applications may present data in a boilerplate fashion or using traditional rules such as displaying fields in alphabetical order. The data may be presented in such a way that is unreadable or illogical to a user. Further, editing these applications created using the developer tools can be an arduous task by developers to correct the deficiencies of these development tools.

Application developers can use improved tools using artificial intelligence to assist in the development of more user-friendly applications, including user interfaces for those applications, using data and efficient ways to customize those applications.

### SUMMARY

A system of one or more computers can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions.

In one general aspect, a computer implemented method may include accessing a view definition for each entity type in a data file. The computer implemented method may also include accessing a view schema file associated with the accessed view definition. The computer implemented method may include receiving a first input prompt to modify the structure of the data file. The computer implemented method may include creating a method request to a generative pre-trained transformer to construct artificial function calls using the first input prompt and one or more schema definitions from the view schema file. The computer implemented method may include transmitting the method request to the generative pre-trained transformer. The computer implemented method may include receiving the artificial function calls from the generative pre-trained transformer to modify the data file. The computer implemented method may include displaying a plain language description of the artificial function calls. The computer implemented method may include receiving a second input confirming modifications of the structure of the data file according to the plain language description of the artificial function calls. The computer implemented method may include modifying the structure of the data file using the artificial function calls. The computer implemented method may also include generating code for an application using one or more templates, the one or more templates using the modified data file, where the generated code may include content hashes. The computer implemented method may include store the generated code for the application. Other embodiments of this aspect include corresponding computer systems, apparatus, and computer programs recorded on one or more computer storage devices, each configured to perform the actions of the methods.

Implementations may include one or more of the following features. In various embodiments, the view definition may include a list view. In various embodiments, the view definition may include a details view. In various embodiments, the data file may include an extensible markup language file. In various embodiments, the data file may include structures and objects in JavaScript Object Notation (JSON) format. In various embodiments, the computer implemented method may include displaying details for the artificial function calls. In various embodiments, the computer implemented method where the first input prompt is received via a chat function.

Implementation of the described techniques may be performed by a system including various hardware components, as a method or process, or stored as a series of instructions on a computer-readable tangible medium.

The following detailed description and accompanying drawings provide a better understanding of the nature and advantages of various embodiments of the present disclosure.

### BRIEF DESCRIPTION OF THE DRAWINGS

FIG. 1 illustrates a collection of exemplary user interfaces for an application that was generated using traditional developer tools.

FIG. 2 illustrates an exemplary block diagram illustrating various processes for generating user interfaces and for revising user interfaces using artificial intelligence.

FIG. 3 illustrates a first exemplary user interface depicting a details visits page with a start visit feature.

FIG. 4 illustrates a second exemplary user interface depicting a details visits page with a start visit feature that has been translated.

FIG. 5 illustrates a third exemplary user interface depicting a details visits page with a start visit feature after the visit has been started.

FIG. 6 illustrates a fourth exemplary user interface depicting a settings page.

FIG. 7 illustrates a fifth exemplary user interface depicting a language settings page.

FIG. 8 illustrates a sixth exemplary user interface depicting a filter visits feature.

FIG. 9 illustrates a seventh exemplary user interface depicting a map options page.

FIG. 10 illustrates a flowchart for a process for modifying a user interface using artificial intelligence.

FIG. 11 illustrates an exemplary computer system for implementing various embodiments described above.

FIG. 12 illustrates an exemplary computing device for implementing various embodiments described above.

FIG. 13 illustrates an exemplary system for implementing various embodiments described above.

### DETAILED DESCRIPTION

In the following description, for purposes of explanation, numerous examples and specific details are set forth to provide a thorough understanding of the present disclosure. It will be evident, however, to one skilled in the art that various embodiments of the present disclosure as defined by the claims may include some or all of the features in these examples alone or in combination with other features described below and may further include modifications and equivalents of the features and concepts described herein.

As discussed above, various developer tools for creating applications and user interfaces face significant shortcomings. First the developer tools often produce user interfaces that are not initiative to a user and are not organized or ordered in a way that is helpful to a user. The user interfaces generated by the developer tools may present data in a boilerplate fashion or using traditional rules such as displaying fields solely in alphabetical order.

The data may be presented in such a way that is unreadable to a user. Further, editing these applications created using the developer tools can be an arduous task by developers to correct the deficiencies of these artificial intelligence tools.

Described herein are techniques for generating user interfaces assisted by a generative pre-trained transformer code generator. Improved tools can use artificial intelligence to assist in the development of more user-friendly applications, including user interfaces for those applications, using data. Further techniques can allow for efficient ways to customize those applications.

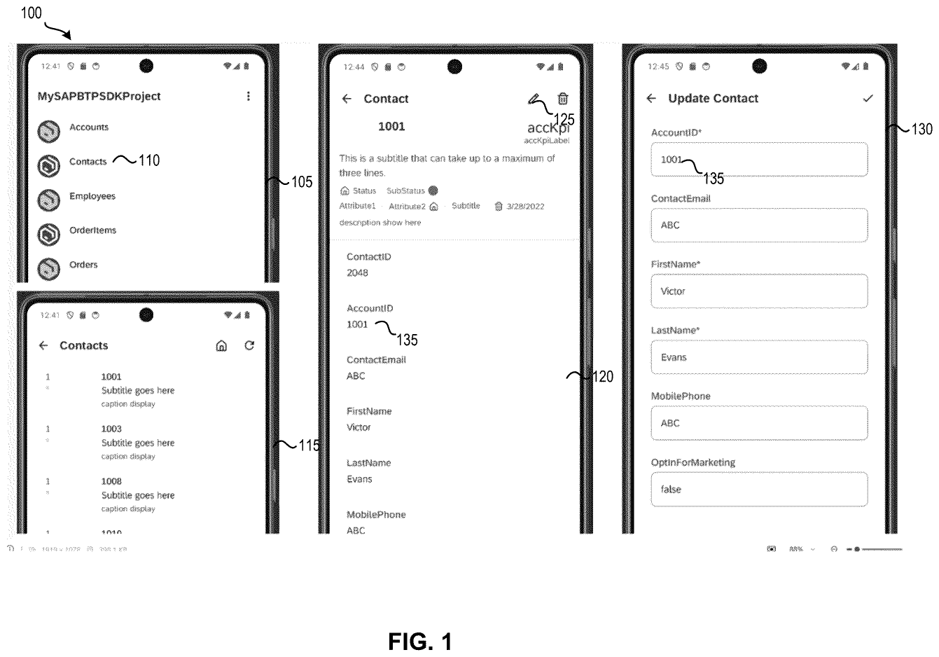

FIG. 1 illustrates a collection 100 of exemplary user interfaces for an application that was generated using traditional developer tools. The collection 100 of user interfaces for an application is used to illustrate some but not all of the shortcomings of applications developed by developer application tools. The shortcomings are independent of the platform (e.g., iOS, Android, etc.) or device that the application is being executed on. The shortcomings also exist for various types of applications (e.g., business specific applications, personal finance applications, entertainment applications, networking applications, etc.).

A first portion 105 of the collection 100 of exemplary user applications illustrates a portion of a menu screen for a fictional application entitled “MySAPBTPSDKProject.” The first portion 105 can display various different menu items that can be created for the data by developer tools. For example, as shown in the first portion 105, the menu can list various features such as but not limited to Accounts, Contacts, Employees, Order Items, and Orders. Selecting any one of these features can open different user interfaces. For example, selecting the Contacts key 110 can result in opening the contacts user interface 115.

The contacts user interface begins to illustrate some of the challenges associated with developer tools. Instead of presenting a list of names in logical order (e.g., alphabetical order by last name) the contacts user interface 115 displays number (e.g., “1001”, “1003”, and “1008”) because the developer tool did not select the correct fields and data to complete the contacts user interface in such a way that would be usable. Further none of the subfields are completed. As shown, the developer user application does not show any useful information because the developer tool is likely keyed in on the account ID for contact information. But AccountID is not really a useful metric for a user as opposed to the unique ID for the contact. In addition, most of the fields are in alphabetical order. The names are displayed exactly as they are stored in the metadata. The spacing for the information is not altered in any way to make the information more readable for a user.

The developer tool user interface may not be informed by AI, so the developer tools would not be informed on the data elements that should be highlighted in in the header on the details screen or the information that a user would find helpful on a list screen.

While the developer tool may produce an application, it leaves many developer hours altering the application to be usable.

The second portion 120 of the collection 100 of exemplary user interfaces illustrates a details page for the contact. This illustrates that the contact information for contact 1001 is indeed stored in the data and it would be more helpful to the user if the name “Victor Evans” or “Evans, Victor” were displayed in the contacts list instead of the number of the contact (e.g., 1001). Developer tools may allow correction of this information for the application by updating the contact using the edit button 125 which would open the update contact portion 130. A user can update the account ID 135 with the appropriate account ID for the contact, but without an extra screen to easily let them select that account ID from a list of available accounts, it would be an arduous and time-consuming task. Alternatively, a developer would have to edit many lines of code to present information in a logical and user-friendly format.

There are many other shortcomings with user interfaces generated by developer tools which are not illustrated in FIG. 1. Correcting these interfaces will be an arduous task for the developer to manually accomplish by editing the many lines of code for the application.

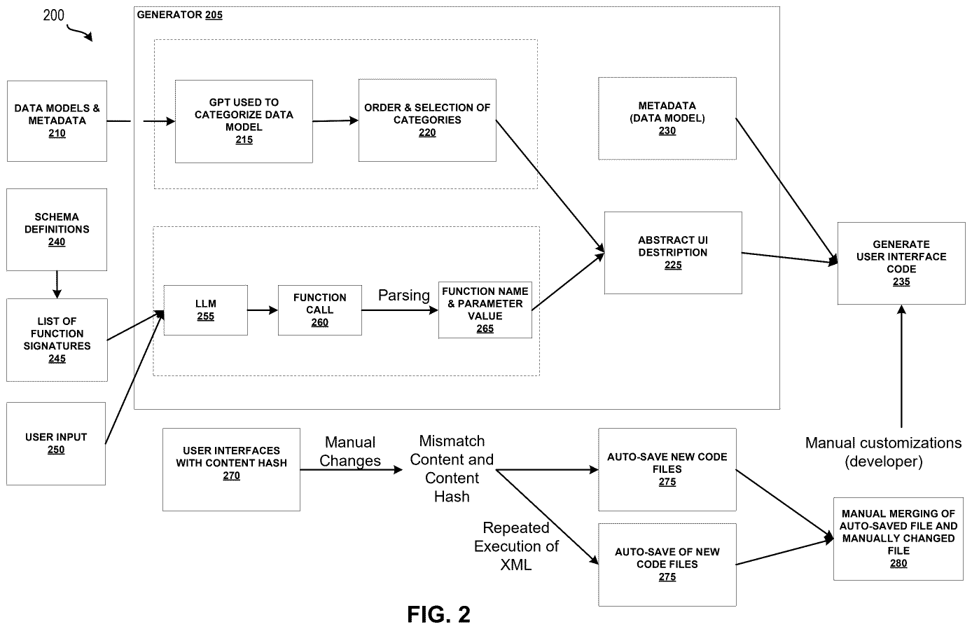

FIG. 2 illustrates an exemplary block diagram 200 illustrating various processes for generating user interfaces and for revising user interfaces using artificial intelligence.

The processes can use data files such as OData metadata documents. An OData metadata document is a data file such as an XML document or a JSON document that describes the structure and capabilities of an OData (Open Data Protocol) service. OData is a protocol used for building and consuming RESTful APIs, and its metadata document plays a key role in exposing the schema of the underlying data to clients in a standardized way.

The metadata document is automatically generated by an OData service and provides details about the entities, relationships, data types, and operations available through the service. This metadata enables clients to understand how to query and interact with the service.

The metadata document defines the entity types, which represent the data models (like database tables) exposed by the service. Each entity type contains a set of properties (fields or columns), their data types, and other constraints like keys and nullability.

The metadata document defines the entity sets. An entity set is a collection of instances of a specific entity type (similar to a table in a relational database). The metadata document defines these entity sets and their relationships.

A complex type of OData document is a structured type within the metadata that can group multiple properties but does not have its own key (unlike entity types). It can be used for reusable data structures like addresses or contact information.

The metadata document also defines relationships (or associations) between entities, such as one-to-one, one-to-many, or many-to-many relationships. These are often referred to as navigational properties, allowing clients to navigate between related entities.

OData supports exposing custom operations or actions that go beyond standard CRUD (Create, Read, Update, Delete) operations. These are defined in the metadata as functions (which are read-only operations) and actions (which can modify data).

The metadata document describes the data types of each property, including primitive types like strings, integers, dates, etc., as well as custom data types defined by the service.

OData documents provide annotations and provide additional semantic information about the data, such as constraints, validation rules, or display hints. These help clients understand how to use or present the data.

A generator 205 can refer to an application or system built using Generative Pre-trained Transformer (GPT) models, like OpenAI's GPT, to generate text. GPT models are large neural networks designed to understand and generate human-like language based on the input they receive. They work by predicting the next word in a sentence, which enables them to create coherent and contextually relevant text across a variety of tasks.

According to the disclosed techniques data models and associated metadata 210 can be provided as an input to the generator. A data model is an abstract representation of the structure, relationships, and constraints of data in a system. It provides a framework for organizing and defining data elements and their interactions, enabling efficient data management and storage. Data models are essential in software development, database design, and information management, as they help ensure data integrity, consistency, and accessibility.

Metadata is often described as data about data. In the context of a data model, metadata provides essential information that describes the characteristics, structure, and context of the data within the model. It plays a crucial role in understanding how to manage, interpret, and use the data effectively. The metadata can include descriptive metadata, structural metadata, administrative metadata, technical metadata, and contextual metadata. Descriptive Metadata provides information about the data's content, context, and purpose. It helps users understand the data and its significance. Structural Metadata describes the organization and structure of the data, including how different data elements are related.

Administrative Metadata provides information needed to manage and maintain the data model, including details about data governance, security, and usage.

Technical Metadata relates to technical specifications and requirements for storing, processing, and retrieving the data.

Contextual Metadata provides context about how the data was collected, processed, and used. This can help users understand the limitations and applicability of the data.

OData documents can include navigation properties that describe relationships between pieces of data in the data file.

In addition, generator 205 can be provided with a list of predefined categories related to a business system. The techniques can generate a command request to the GPT to categorize portions of the data model entity type names using predefined categories (e.g., address, document, event, organization, person).

At block 215, the generator 205 can categorize the data model property names into predefined categories (e.g., name, address, phone, email, location, priority, and status.)

At block 220, the generator 205 can use a predefined list for ordering and selection of categories based on typical conventions for business application user interfaces. The predefined list can be used to generate labels, features, and ordering for user interfaces for an application.

At block 225, generator 205 can produce an abstract User Interface (UI) description of each view (e.g., Home View.xml, ListView.xml, etc.). The Abstract UI and metadata (data model) 230 for a selected entity type can be provided to a code generation template to generate the programming code.

At block 235, the template can generate the user interface code. Program code can be generated using a cross-platform, statically typed, general-purpose high-level programming language with type interface (e.g., Kotlin). Other programming languages can also be used, such as but not limited to, Java, Scala, Swift, Groovy, C#, F#, Dart, Python, and TypeScript.

Kotlin is a modern, statically typed programming language that runs on the Java Virtual Machine (JVM) and is fully interoperable with Java. Kotlin can also be compiled to JavaScript and native code, allowing it to be used in web and mobile development (beyond Android). It is popular among developers due to its modern features, strong tooling support, and seamless integration with Java-based environments.

The programming code can be generated using one or more code generation templates and the labels and features for the application provided from generator 205. Code generation templates are predefined structures or formats used to automatically generate source code based on specific inputs or configurations. These templates act as blueprints for creating repetitive or standardized code efficiently, saving developers time and reducing the chances of errors. Code generation templates are commonly used in software development tools, frameworks, and environments to automate coding tasks.

Templates contain placeholders for variable data that can be dynamically filled in. This might include classes, methods, functions, or other code components that follow a specific pattern. Developers can customize the template by providing different inputs or configurations, such as names of classes, variables, functions, or specific functionality, allowing the generated code to fit their specific use case. Once a template is created, it can be reused across different projects, allowing for rapid code generation in various scenarios without manually rewriting the same code repeatedly. Code generation templates help ensure that coding practices and standards are consistently applied, reducing errors due to manual coding. Code generation templates significantly reduce development time by automating the creation of repetitive or boilerplate code, such as data models, Create, Read, Update, Delete (CRUD) operations, configurations, etc.

Some exemplary code generation templates can include but are not limited to Django, Ruby, and Spring Boot. Django (Python) or Ruby on Rails use templates for generating models, controllers, views, and other components based on a single command, streamlining web development. Spring Boot (Java) has templates for generating boilerplate code for REST controllers, services, and repositories. Application Programming Interfaces (APIs) development tools like Swagger or OpenAPI use templates to automatically generate client SDKs in multiple languages from API specifications. Tools like Entity Framework (C#) or SQLAlchemy (Python) can generate database migration scripts using code generation templates based on changes in the data model. Front-end frameworks like Angular and React provide templates to generate components, services, and modules through command-line interfaces (CLI).

In various embodiments, the application code can be stored in a memory (e.g., a cloud-based storage system).

In another aspect, chat features can be used to customize an application.

Schema definitions 240, a list of function signatures 245, and user input 250 can be provided to the generator 205. In various embodiments, the list of function signatures 245 and user input 250 can be provided to the large language model (LLM) 255. A schema definition 240 for code can refer to a formal or informal description of the structure, syntax, and elements that make up a codebase, allowing a program or system to interpret, validate, or process the code.

A schema is a formal specification of how data is organized and structured. When applied to code, this often refers to defining valid formats for code configuration, data inputs, or outputs in a specific language like JSON, XML, or YAML. A schema allows a developer/programmer to validate the structure and type of data against predefined rules. A schema for defining the grammar or syntax of a programming language. This defines how valid statements and expressions are structured. In formal language theory, this is often done using Backus-Naur Form (BNF) or Extended BNF (EBNF). It describes how tokens (like keywords, operators, or literals) are combined to form valid programs.

In languages with static type systems, a schema definition refers to how types are defined and structured. This could include definitions for data types, interfaces, or abstract classes that outline how the program's entities (objects, functions, etc.) interact.

The schema definition, including a list of function signatures of artificial functions to add/remove/edit code elements, can be provided to the generator 205. A function signature in programming defines the function's name, its parameters (including types), and its return type.

A chat feature can be used to receive user inputs 250 from a user (e.g., a developer or programmer). The inputs can describe the changes desired for the application. For example, the received inputs can include an input such as “the user does not want to see the order items.”

The schema definition 240, the list of function signatures 245, and received inputs 250 can be provided to a large language model feature in the generator 205. Large language models are typically based on architectures like transformers (e.g., GPT, BERT, T5) and arc used for a variety of natural language processing (NLP) tasks such as text generation, translation, summarization, question answering, and more.

The generator 205 can generate a function call 260. A function call 260 refers to the process of invoking or executing a function or a method defined in the code. Functions are reusable blocks of code that perform specific tasks and calling a function means asking the program to execute that block of code at a specific point during the execution of the application. An artificial function call in application programming typically refers to a mock function or stub that simulates the behavior of a real function during testing or development. Artificial function calls are commonly used in unit testing or test-driven development (TDD) to isolate specific parts of code, especially when the real function or external dependency is complex, slow, or unavailable.

Next, the function call can be parsed to determine the function name and parameter values 265. Parsing function calls refers to the process of analyzing and interpreting the function call syntax in source code to understand its structure and meaning. This process is typically carried out by a parser in a compiler or interpreter, which breaks down the function call into its constituent parts (such as the function name, arguments, and return values) and determines how the call should be executed in the context of the program. The source code is first broken down into tokens (basic units like keywords, identifiers, operators, etc.). For a function call, the tokens might include the function name, parentheses, commas, and arguments.

The tokens are then analyzed based on the language's grammar rules. During this stage, the parser checks if the function call follows the correct syntax. If the function call is valid, the parser builds a syntax tree (or abstract syntax tree (AST)) to represent the structure of the function call. The parser can confirm that the function call adheres to the grammar of the language.

After parsing semantic analysis can be performed to determine the function call's meaning is analyzed to ensure it makes sense in the program.

The techniques use the function name and parameter values 265 to identify which portion of the data file should be modified. The function name and parameter values 265 can be provided to the abstract UI and then to the code generation template for generation of programming code at block 235.

A developer can provide manual customization of the code. In a manual customization path, user interfaces in a programming language with content hash 270 can be used. A content hash in programming is a unique identifier generated from the contents of a file, data, or any block of information. The content itself is processed through a hashing algorithm (like MD5, SHA-256, etc.) to produce a fixed-size hash value, also known as a digest. This hash represents the data's content, such that even a slight change in the data will produce a completely different hash.

Manual changes can be performed on the user interfaces. A process such as an algorithm can be performed to determine a mismatch between the content and the content hash. The auto-save features 275 can be used to save the new code files. This process can be repeated as necessary, followed by auto-saving the new code files.

At block 280, the technique can manually merge the auto-saved file and manually change the data file.

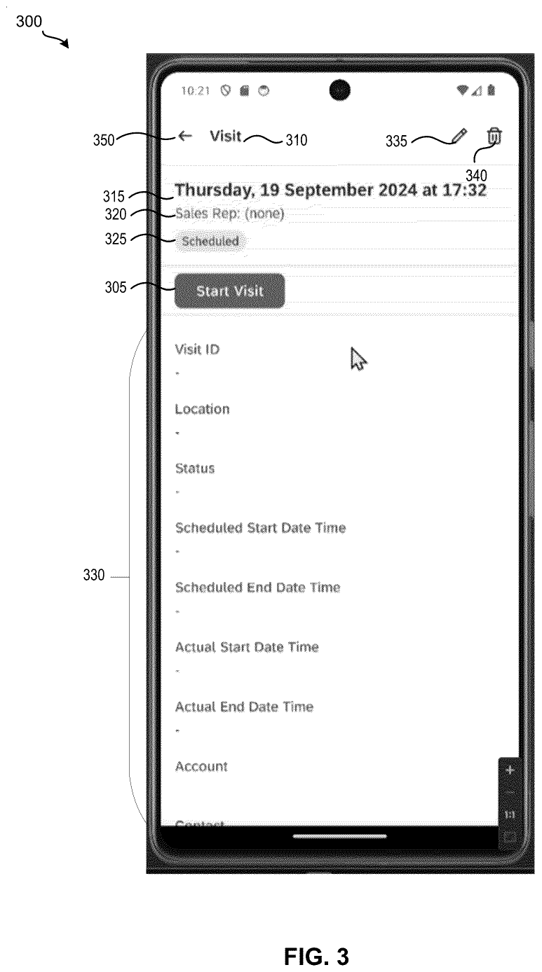

FIG. 3 illustrates a first exemplary user interface 300 depicting a details visits page with a start visit feature 305. The first exemplary user interface 300 can display the title 310 of the user interface. The first exemplary user interface 300 displays the date and time information 315 for the visit, the contact 320 for the visit, and the status 325 of the visit (e.g., scheduled, cancelled, started, finished, etc.). The first exemplary user interface 300 can use different colors for different status 325. The first exemplary user interface 300 can display various details regarding the visit. The visits details 330 can include, but are not limited to, a Visit ID, Location of Visit, Status, Scheduled Start Date Time, Scheduled End Date Time, Actual Start Date Time, Actual End Date Time, Account, Contact.

The first exemplary user interface 300 can display an edit icon 335 and a trashcan icon 340. Selecting the edit icon 335 can allow a user to edit the information in the contact. Selecting the trashcan icon 340 can delete the contact. The first exemplary user interface 300 can display a back button 350. The back button 350 can return the user to a previous user interface or return the user to the menu/list user interface.

The first exemplary user interface 300 can display a start visit button 305. The start visit button 305 is one example of a modification that a developer may wish to make to the first exemplary user interface 300. The start visit button 305 can allow a user to quickly capture the actual start and date information for the particular visit and change the status 325 of the visit to started. Depressing the start visit button 305 a second time can capture the end date and time for the visit and changing the status 325 of the visit to ended. This can be an example of a feature that a developer may wish to add to an application to make the application more user-friendly.

The fifteenth exemplary user interface 300 is merely one example of one potential user interface created with the data models and metadata as organized using artificial intelligence. Other user interface configurations are possible.

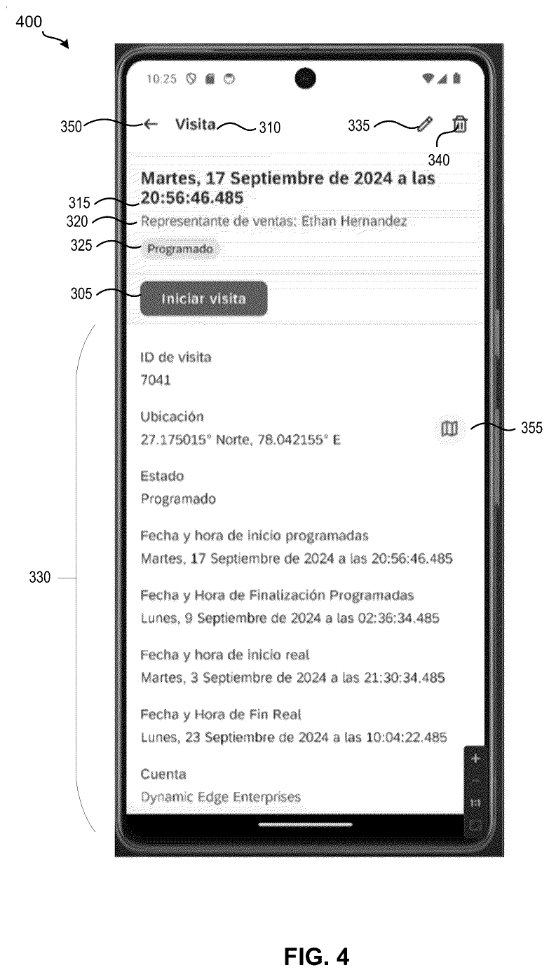

FIG. 4 illustrates a second exemplary user interface 400 depicting a details visits page with a start visit feature that has been translated. Another modification a developer may desire for the second exemplary user interface 400 is to translate the content. In FIG. 4, the content is translated into Spanish. The second exemplary user interface 400 can display the title 310 of the user interface. The second exemplary user interface 400 displays the date and time information 315 for the visit, the contact 320 for the visit, and the status 325 of the visit (e.g., scheduled, cancelled, started, finished, etc.). The second exemplary user interface 400 can use different colors for different status 325. The second exemplary user interface 400 can display various details regarding the visit. The visits details 330 can include, but are not limited to, a Visit ID, Location of Visit, Status, Scheduled Start Date Time, Scheduled End Date Time, Actual Start Date Time, Actual End Date Time, Account, Contact. Abeam the location of visit information can be a map icon 355. The map icon 355 can provide a link to an electronic map. Selecting the map icon 355 can display a map.

The second exemplary user interface 400 can display an edit icon 335 and a trashcan icon 340. Selecting the edit icon 335 can allow a user to edit the information in the contact. Selecting the trashcan icon 340 can delete the contact. The second exemplary user interface 400 can display a back button 350. The back button 350 can return the user to a previous user interface or return the user to the menu/list user interface.

The second exemplary user interface 400 can display a start visit button 305. The start visit button 305 can allow a user to quickly capture the actual start and date information for the particular visit and change the status 325 of the visit to started. Depressing the start visit button 305 a second time can capture the end date and time for the visit and changing the status 325 of the visit to ended. This can be an example of a feature that a developer may wish to add to an application to make the application more user-friendly.

The second exemplary user interface 400 contains the same information as the fifteenth exemplary user interface 300, however the information has been translated into a different language. Translating the user interface information into any one of a variety of languages is another example of a user/developer seeking to modify the application to make it more user-friendly.

The second exemplary user interface 400 is merely one example of one potential user interface created with the data models and metadata as organized using artificial intelligence. Other user interface configurations are possible.

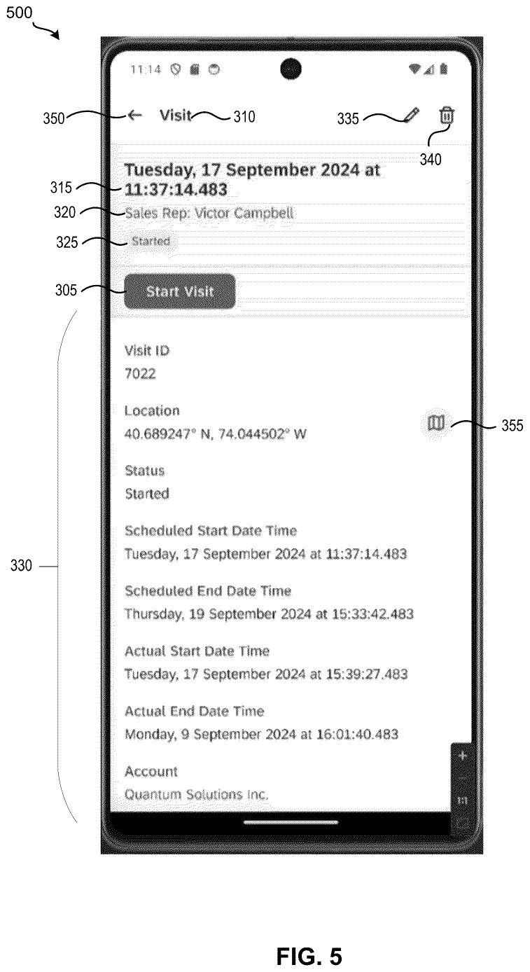

FIG. 5 illustrates a third exemplary user interface 500 depicting a details visits page with a start visit feature after the visit has been started. The third exemplary user interface 500 can display the title 310 of the user interface. The third exemplary user interface 500 displays the date and time information 315 for the visit, the contact 320 for the visit, and the status 325 of the visit (e.g., scheduled, cancelled, started, finished, etc.). The third exemplary user interface 500 can use different colors for different status 325. The third exemplary user interface 500 can display various visit details 330 regarding the visit. The visits details 330 can include, but are not limited to, a Visit ID, Location of Visit, Status, Scheduled Start Date Time, Scheduled End Date Time, Actual Start Date Time, Actual End Date Time, Account, Contact. Abeam the location of visit information can be a map icon 355. The map icon 355 can provide a link to an electronic map.

The third exemplary user interface 500 can display an edit icon 335 and a trashcan icon 340. Selecting the edit icon 335 can allow a user to edit the information in the contact. Selecting the trashcan icon 340 can delete the contact. The third exemplary user interface 500 can display a back button 350. The back button 350 can return the user to a previous user interface or return the user to the menu/list user interface.

The third exemplary user interface 500 can display a start visit button 305. The start visit button 305 can allow a user to quickly capture the actual start and date information for the particular visit and changes the status 325 of the visit to started. The third exemplary user interface 500, illustrates that the start visit button 305 has been selected changing the status 325 to “Started” and capturing the Actual Start Date/Time for the visit.

Depressing the start visit button 305 a second time can capture the end date and time for the visit and changing the status 325 of the visit to ended. This can be an example of a feature that a developer may wish to add to an application to make the application more user-friendly.

The third exemplary user interface 500 is merely one example of one potential user interface created with the data models and metadata as organized using artificial intelligence. Other user interface configurations are possible.

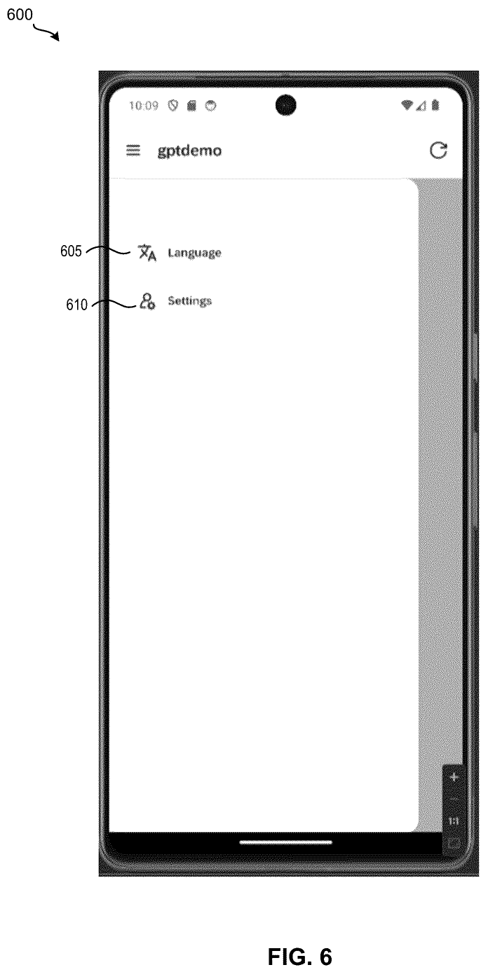

FIG. 6 illustrates an fourth exemplary user interface 600 depicting a settings page. The fourth exemplary user interface 600 allows a user to select a language button 605 and a settings button 610. The fourth exemplary user interface 600 is merely an example of a potential user interface created with data models and metadata as organized using artificial intelligence. Other user interface configurations are possible.

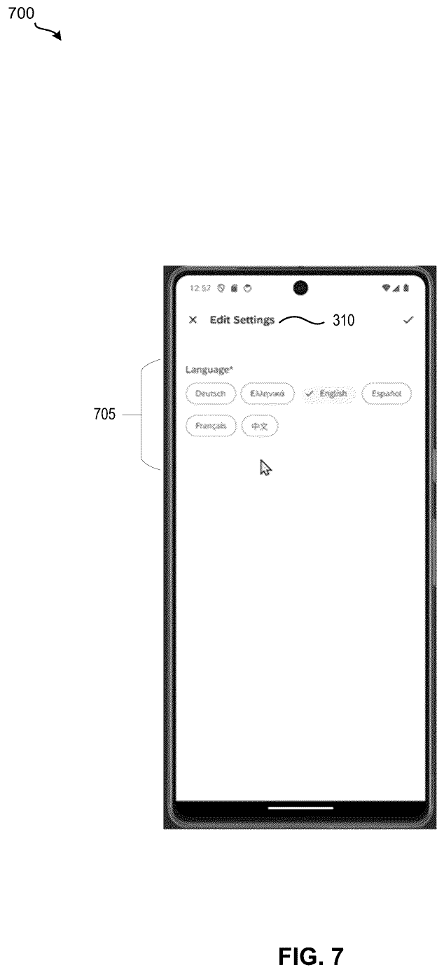

FIG. 7 illustrates a fifth exemplary user interface 700 depicting a language settings page. The fifth exemplary user interface 700 can display the title 310 of the user interface. The fifth exemplary user interface 700 displays a plurality of language icons 705 to translate the contents of the application into the selected language. The fifth exemplary user interface 700 is merely one example of one potential user interface created with the data models and metadata as organized using artificial intelligence. Other user interface configurations are possible.

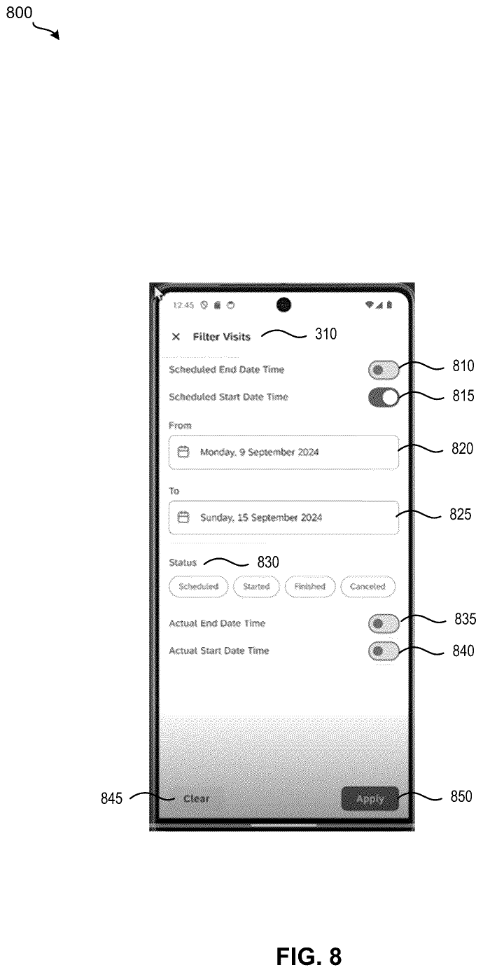

FIG. 8 illustrates a sixth exemplary user interface 800 depicting a filter visits feature. The sixth exemplary user interface 800 can display the title 310 of the user interface. The filters visit user interface allows a user to filter visits by scheduled end date/time 810 and/or a scheduled start date/time 815. The sixth exemplary user interface 800 allows a user to filter visits between a first calendar date 820 and a second calendar data 825. The sixth exemplary user interface 800 allows a user to filter visits by a selected status 830 of the meeting. The filters visit user interface allows a user to filter visits by actual end date/time 835 and/or an actual start date/time 840. The filters can be applied by depressing the Apply button 845. The filters can be cleared by depressing the clear button 850.

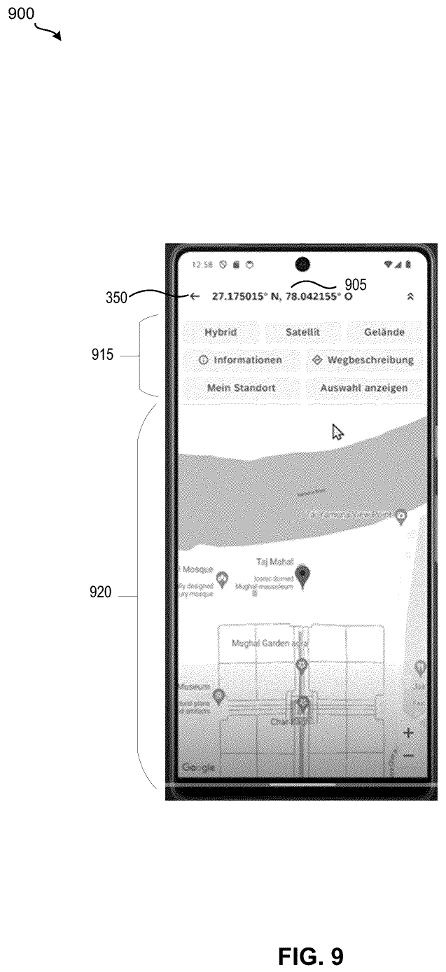

FIG. 9 illustrates a seventh exemplary user interface 900 depicting a map options page. The seventh exemplary user interface 900 can display the coordinates 905 for the meeting location. The coordinates can be displayed as latitude and longitude. The seventh exemplary user interface 700 can display a back button 350. The back button 350 can return the user to a previous user interface or return the user to the menu/list user interface.

A geographic map 920 illustrating the meeting location can also be displayed.

The seventh exemplary user interface 900 can display various map features 910 that can be selected by a user. The map features 910 can include Hybrid map, Satellite map etc.

The seventh exemplary user interface 900 is merely one example of one potential user interface created with the data models and metadata as organized using artificial intelligence. Other user interface configurations are possible.

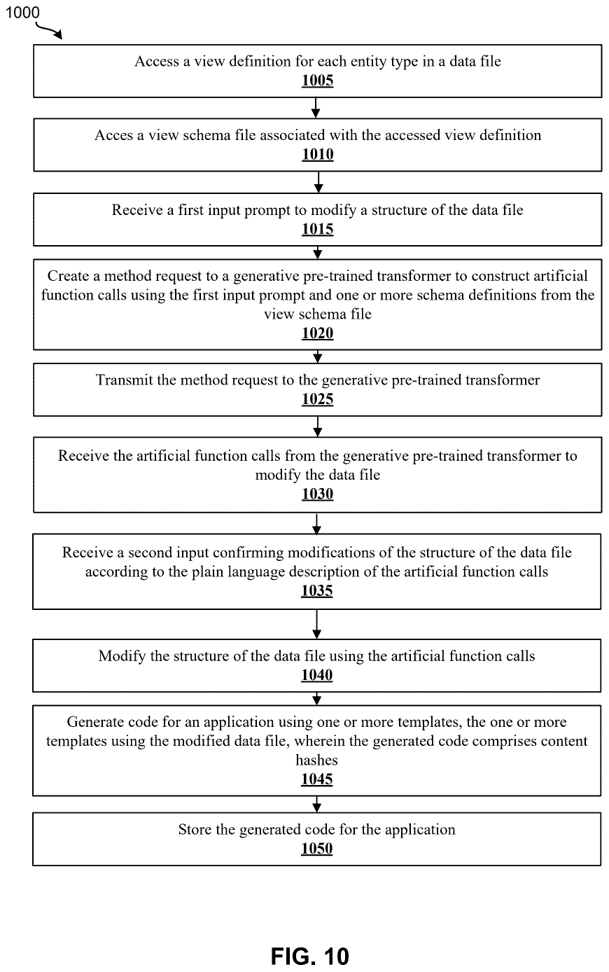

FIG. 10 illustrates a flowchart for a process 1000 for modifying a user interface using artificial intelligence. In some implementations, one or more process blocks of FIG. 10 may be performed by a computing device.

At block 1005, process 1000 may include accessing a view definition for each entity type in a data file. For example, computing devices may access a view definition for each entity type in a data file, as described above. In application development, a view definition refers to how a particular user interface (UI) screen or web page is structured and organized, often as part of a Model-View-Controller (MVC) or similar architecture. The view definition can include various components such as layout and structure, presentation logic, data binding, and interaction handling. Layout and Structure can describe how UI elements (buttons, text fields, tables, etc.) are arranged on the screen. This can involve HTML for web applications or XML for mobile apps. Presentation Logic can define the appearance (e.g., colors, fonts, sizes) and how the UI will react to user inputs or data changes. This is handled by frameworks or libraries like CSS, React, or Android's UI toolkit. Data Binding can describe how the UI is connected to the underlying data models. Changes in data often trigger updates in the view automatically in modern frameworks. The Interaction Handlers can specify how the view will handle user interactions like clicks, taps, or form submissions, often tied to controller logic or view-model actions in frameworks like Angular or Vue.js.

A view is often defined in XML to layout elements like buttons, lists, or text fields. Java/Kotlin or Swift (for iOS) can handle the interaction logic. A view definition in application development represents how the UI is defined and behaves, managing the visual layer of the application.

The view definition for each entity type in a data file can be stored in a memory (e.g., a cloud-based storage system).

At block 1010, process 1000 may include accessing a view schema file associated with the accessed view definition. In application development, a view schema is a more technical concept than a view definition and usually relates to how data is presented in a specific format, particularly in the context of databases or data-driven applications.

For example, there could be AccountList View.xml, ContactList View.xml, OrderList View.xml and ProductListView.xml (separate XML view definitions). There would be a single ListView.xsd view schema, which describes the general form of any *ListView.xml file. Similarly, there could be AccountDetailView.xml, ContactDetailView.xml, OrderDetailView.xml and ProductDetailView.xml (separate XML view definitions). There would be a single DetailView.xsd view schema, which describes the general form of any *DetailView.xml file. Therefore, each view definition can be for a particular screen, whereas a view schema can be for a particular KIND of screen (e.g., home view, list view, detail view). View definitions can be generated by the generator with the GPT's assistance. View schemas can be included with the generator (although a developer could alter them).

In Model-View-Controller (MVC) or other architectural patterns, a view schema refers to how data is structured for presentation to the user. It defines the data model that will be used in the view layer to display information. The schema outlines which parts of the underlying data model will be displayed in the user interface. The view schema can provide Data Formatting which may involve formatting, aggregation, or transformation of data to make it suitable for presentation. The view schema may provide Data Binding by ensuring that the view is connected to the data in a way that automatically updates when the data changes (e.g., using frameworks like Angular, React, or Django).

For example, a computing device may access a view schema file associated with the accessed view definition, as described above. See view definitions for each entity type above.

At block 1015, process 1000 may include receiving a first input prompt to modify the structure of the data file. For example, computing devices may receive a first input prompt to modify the structure of the data file, as described above. In various embodiments, the first input prompt is received via a chat function.

Example steps for “chat-to-modify” of ContactListView.xml view definition, assuming the developer asks the generator to “show ContactEmail in the subheadline.” (1) The generator can use content of the ListView.xsd view schema to (a) generate a list of artificial functions (with function name and parameter types) e.g., one of which can be the following: {“methodName”: “setItemSubheadlineTextTo,” “parameters”: {“text”: “???”}. The generator can also generate (b) a corresponding list of plain language ways to express each function call e.g., one of which could be “set item subheadline text to ‘<text>’.” The generator can also (c) generate a corresponding list of XPath expressions that can take the parameters of an artificial function call and identify the part of the view definition that needs to be added/changed/removed e.g., one of which could be: /item/subheadline/@text.

(2) The generator can create a prompt for the GPT, including the developer task “show ContactEmail in the subheadline”, the artificial functions and plain language (from (1) (a) and (b)), and command the GPT to choose one or more artificial functions for the developer task and to substitute any occurrences of “???” with the appropriate text.

(3) The GPT can process the inputs and responds with the following: {“methodName”: “setItemSubheadlineTextTo,” “parameters”: {“text”: “ContactEmail”}}. (4) The generator parses this GPT response, looks up (in memory) the remembered XPath expression from (1) (c) (which the GPT did not need to know about), and then the generator adds (or changes, if already present) the XML element at XPath “/item/subheadline” in the ContactListView.xml to include “ContactEmail” as the value for the XML “text” attribute of the XML “subheadline” element. (5) The generator can re-execute the code generation templates to regenerate the relevant application code.

At block 1020, process 1000 may include creating a method request to a generative pre-trained transformer to construct artificial function calls using the first input prompt and one or more schema definitions from the view schema file. In various embodiments, the method request may be a command request for a GPT. For example, computing devices may generate a method request to a generative pre-trained transformer to construct artificial function calls using the first input prompt and one or more schema definitions from the view schema file, as described above. The code generator, using the schema definition, constructs a list of function signatures for artificial (nonexistent) functions. Each of these function signatures can be associated with an *XPath expression* (which designates an XML element to be added, changed or removed). The GPT can be asked to the convert developer's editing task description into a call to one or more of the artificial functions

At block 1025, process 1000 may include transmitting the method request to the generative pre-trained transformer. For example, computing devices may transmit the method request to the generative pre-trained transformer, as described above. In various embodiments, the method request can be transmitted via a network e.g., the Internet.

At block 1030, process 1000 may include receiving artificial function calls from the generative pre-trained transformer to modify the data file. For example, computing devices may receive artificial function calls from the generative pre-trained transformer to modify the data file, as described above. In various embodiments, the view definition may include a details view. In various embodiments, the artificial function calls can be received via a network, e.g., the Internet.

In various embodiments, the data file may include an extensible markup language file. In various embodiments, the data file may include structures and objects in JavaScript Object Notation (JSON) format.

In various embodiments, process 1000 may include displaying a plain language description of the artificial function calls. For example, a computing device may display a plain language description of the artificial function calls, as described above. In various embodiments, process 1000 may include displaying details for the artificial function calls.

At block 1035, process 1000 may include receiving a second input confirming modifications of the structure of the data file according to the plain language description of the artificial function calls. For example, computing devices may receive a second input confirming modifications of the structure of the data file according to the plain language description of the artificial function calls, as described above. The second input can be as simple as a “yes” or “no” confirming that the proposed modifications are correct. In various embodiments, the second input is received via a chat function.

At block 1040, process 1000 may include modifying the structure of the data file using the artificial function calls. For example, computing devices may modify the structure of the data file using the artificial function calls, as described above.

At block 1045, process 1000 may include generating code for an application using one or more templates, the one or more templates using the modified data file, where the generated code may include content hashes. For example, computing devices may generate code for an application using one or more templates using the modified data file, where the generated code may include content hashes, as described above.

In various embodiments, the above steps resulted in generation of a final Kotlin application code file ContactListView.kt. This can include a content-hash. Suppose the developer then hand-modifies the Kotlin application code file ContactList View.kt. Later the developer does another chat-to-modify which results in ContactList View_new.kt. The generator can put the new generated code into a different file so that the developer's hand-modified changes are not lost. A difference-based manual or automated merger of the ContactList View.kt and the ContactList View_new.kt can preserve both the hand modification and the newly regenerated content. Therefore, the content-hashes are to do with the final application code file(s), not the XML view definitions.

At block 1050, process 1000 may include storing the generated code for the application. For example, a computing device may store the generated code for the application, as described above. The generated code can be stored in a memory (e.g., a cloud-based storage system).

Process 1000 may include additional implementations, such as any single implementation or any combination of implementations described below and/or in connection with one or more other processes described elsewhere herein. In an exemplary implementation, the view definition may include a list view.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

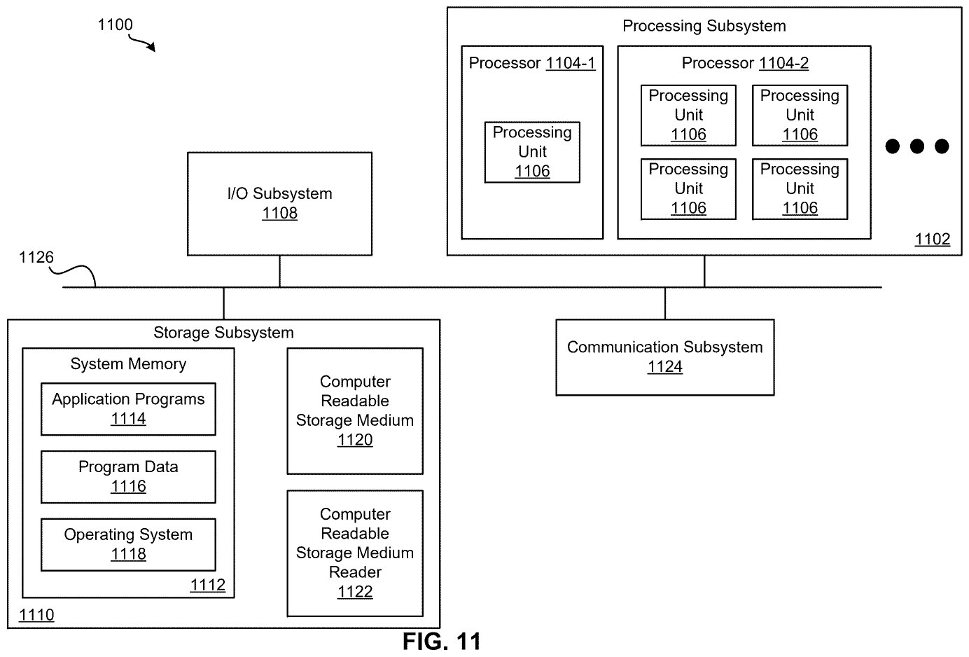

FIG. 11 illustrates an exemplary computer system 1100 for implementing various embodiments described above. Computer system 1100 may be a desktop computer, a laptop, a server computer, or any other type of computer system or combination thereof. In addition, computer system 1100 can implement many of the operations, methods, and/or processes described above (e.g., process 1000). As shown in FIG. 11, computer system 1100 includes processing subsystem 1102, which communicates via bus subsystem 1126, with input/output (I/O) subsystem 1108, storage subsystem 1110 and communication subsystem 1124.

Bus subsystem 1126 is configured to facilitate communication among the various components and subsystems of computer system 1100. While bus subsystem 1126 is illustrated in FIG. 11 as a single bus, one of ordinary skill in the art will understand that bus subsystem 1126 may be implemented as multiple buses. Bus subsystem 1126 may be any of several types of bus structures (e.g., a memory bus or memory controller, a peripheral bus, a local bus, etc.) using any of a variety of bus architectures. Examples of bus architecture may include an Industry Standard Architecture (ISA) bus, a Micro Channel Architecture (MCA) bus, an Extended ISA (EISA) bus, a Video Electronics Standards Association (VESA) local bus, a Peripheral Component Interconnect (PCI) bus, a Universal Serial Bus (USB), etc.

Processing subsystem 1102, which can be implemented as one or more integrated circuits (e.g., a conventional microprocessor or microcontroller), controls the operation of computer system 1100. Processing subsystem 1102 may include one or more processors 1104. Each processor 1104 may include one processing unit 1106 (e.g., a single core processor such as processor 1104-1) or several processing units 1106 (e.g., a multicore processor such as processor 1104-2). In some embodiments, processors 1104 of processing subsystem 1102 may be implemented as independent processors while, in other embodiments, processors 1104 of processing subsystem 1102 may be implemented as multiple processors integrate into a single chip or multiple chips. Still, in some embodiments, processors 1104 of processing subsystem 1102 may be implemented as a combination of independent processors and multiple processors integrated into a single chip or multiple chips.

In some embodiments, processing subsystem 1102 can execute a variety of programs or processes in response to program code and can maintain multiple concurrently executing programs or processes. At any given time, some or all of the program code to be executed can reside in processing subsystem 1102 and/or in storage subsystem 1110. Through suitable programming, processing subsystem 1102 can provide various functionalities, such as the functionalities described above by reference to process 1000.

I/O subsystem 1108 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 1100 to a user or another device (e.g., a printer).

As illustrated in FIG. 11, storage subsystem 1110 includes system memory 1112, computer-readable storage medium 1120, and computer-readable storage medium reader 1122. System memory 1112 may be configured to store software in the form of program instructions that are loadable and executable by processing subsystem 1102 as well as data generated during the execution of program instructions. In some embodiments, system memory 1112 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 1112 may include different types of memory, such as static random-access memory (SRAM) and/or dynamic random-access memory (DRAM). System memory 1112 may include a basic input/output system (BIOS), in some embodiments, which is configured to store basic routines to facilitate transferring information between elements within computer system 1100 (e.g., during start-up). Such a BIOS may be stored in ROM (e.g., a ROM chip), flash memory, or any other type of memory that may be configured to store the BIOS.

As shown in FIG. 11, system memory 1112 includes application programs 1114, program data 1116, and operating system (OS) 1118. OS 1118 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple IOS, Windows Phone, Windows Mobile, Android, BlackBerry OS, Blackberry 10, and Palm OS, WebOS operating systems.

Computer-readable storage medium 1120 may be a non-transitory computer-readable medium configured to store software (e.g., programs, code modules, data constructs, instructions, etc.). Many of the components and/or processes (e.g., process 1000) described above may be implemented as software that when executed by a processor or processing unit (e.g., a processor or processing unit of processing subsystem 1102) performs the operations of such components and/or processes. Storage subsystem 1110 may also store data used for, or generated during, the execution of the software.

Storage subsystem 1110 may also include computer-readable storage medium reader 1122 that is configured to communicate with computer-readable storage medium 1120. Together and optionally, in combination with system memory 1112, computer-readable storage medium 1120 may comprehensively represent remote, local, fixed, and/or removable storage devices plus storage media for temporarily and/or more permanently containing, storing, transmitting, and retrieving computer-readable information.

Computer-readable storage medium 1120 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSDs), flash memory card (e.g., secure digital (SD) cards, CompactFlash cards, etc.), USB flash drives, or any other type of computer-readable storage media or device.

Communication subsystem 1124 serves as an interface for receiving data from, and transmitting data to, other devices, computer systems, and networks. For example, communication subsystem 1124 may allow computer system 1100 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 1124 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 1124 may provide components configured for wired communication (e.g., Ethernet) in addition to or instead of components configured for wireless communication.

One of ordinary skill in the art will realize that the architecture shown in FIG. 11 is only an example architecture of computer system 1100, and that computer system 1100 may have additional or fewer components than shown, or a different configuration of components. The various components shown in FIG. 11 may be implemented in hardware, software, firmware, or any combination thereof, including one or more signal processing and/or application specific integrated circuits.

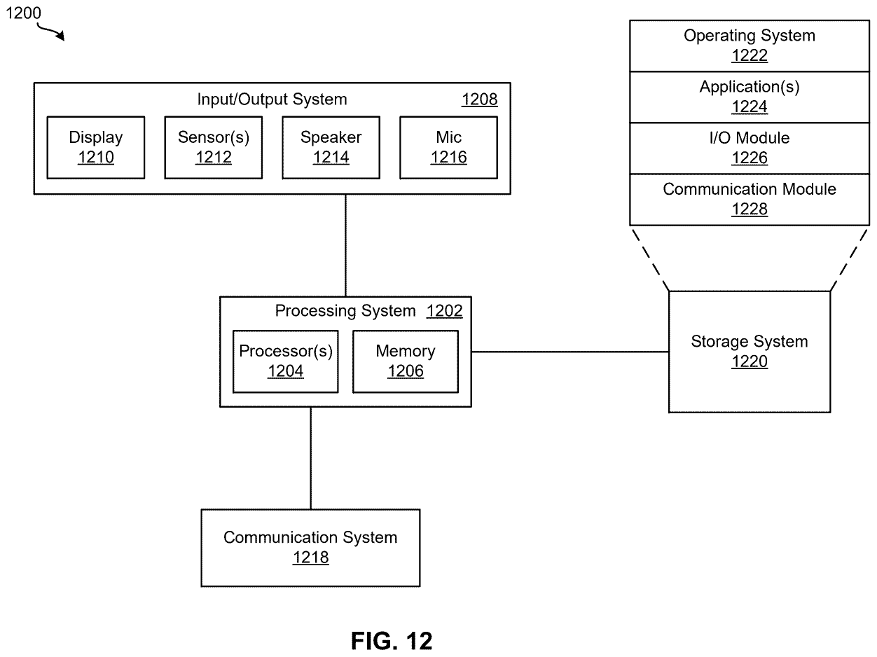

FIG. 12 illustrates an exemplary computing device 1200 for implementing various embodiments described above. Computing device 1200 may be a cellphone, a smartphone, a wearable device, an activity tracker or manager, a tablet, a personal digital assistant (PDA), a media player, or any other type of mobile computing device or combination thereof. In addition, computing device 1200 can implement many of the operations, methods, and/or processes described above (e.g., process 1000). As shown in FIG. 12, computing device 1200 includes processing system 1202, input/output (I/O) system 1208, communication system 1218, and storage system 1220. These components may be coupled by one or more communication buses or signal lines.

Processing system 1202, which can be implemented as one or more integrated circuits (e.g., a conventional microprocessor or microcontroller), controls the operation of computing device 1200. As shown, processing system 1202 includes one or more processors 1204 and memory 1206. Processors 1204 are configured to run or execute various software and/or sets of instructions stored in memory 1206 to perform various functions for computing device 1200 and to process data.

Each processor of processors 1204 may include one processing unit (e.g., a single core processor) or several processing units (e.g., a multicore processor). In some embodiments, processors 1204 of processing system 1202 may be implemented as independent processors while, in other embodiments, processors 1204 of processing system 1202 may be implemented as multiple processors integrated into a single chip. Still, in some embodiments, processors 1204 of processing system 1202 may be implemented as a combination of independent processors and multiple processors integrated into a single chip.

Memory 1206 may be configured to receive and store software (e.g., operating system 1222, applications 1224, I/O module 1226, communication module 1228, etc. from storage system 1220) in the form of program instructions that are loadable and executable by processors 1204 as well as data generated during the execution of program instructions. In some embodiments, memory 1206 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 1208 is responsible for receiving input through various components and providing output through various components. As shown for this example, I/O system 1208 includes display 1210, one or more sensors 1212, speaker 1214, and microphone 1216. Display 1210 is configured to output visual information (e.g., a graphical user interface (GUI) generated and/or rendered by processors 1204). In some embodiments, display 1210 is a touch screen that is configured to also receive touch-based input. Display 1210 may be implemented using liquid crystal display (LCD) technology, light-emitting diode (LED) technology, organic LED (OLED) technology, organic electro luminescence (OEL) technology, or any other type of display technologies. Sensors 1212 may include any number of different types of sensors for measuring a physical quantity (e.g., temperature, force, pressure, acceleration, orientation, light, radiation, etc.). Speaker 1214 is configured to output audio information and microphone 1216 is configured to receive audio input. One of ordinary skill in the art will appreciate that I/O system 1208 may include any number of additional, fewer, and/or different components. For instance, I/O system 1208 may include a keypad or keyboard for receiving input, a port for transmitting data, receiving data and/or power, and/or communicating with another device or component, an image capture component for capturing photos and/or videos, etc.

Communication system 1218 serves as an interface for receiving data from, and transmitting data to, other devices, computer systems, and networks. For example, communication system 1218 may allow computing device 1200 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 1218 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 1218 may provide components configured for wired communication (e.g., Ethernet) in addition to or instead of components configured for wireless communication.

Storage system 1220 handles the storage and management of data for computing device 1200. Storage system 1220 may be implemented by one or more non-transitory machine-readable mediums that are configured to store software (e.g., programs, code modules, data constructs, instructions, etc.) and store data used for, or generated during, the execution of the software. Many of the components and/or processes (e.g., process 1000) described above may be implemented as software that when executed by a processor or processing unit (e.g., processors 1204 of processing system 1202) performs the operations of such components and/or processes.

In this example, storage system 1220 includes operating system 1222, one or more applications 1224, I/O module 1226, and communication module 1228. Operating system 1222 includes various procedures, sets of instructions, software components and/or drivers for controlling and managing general system tasks (e.g., memory management, storage device control, power management, etc.) and facilitates communication between various hardware and software components. Operating system 1222 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple IOS, Windows Phone, Windows Mobile, Android, BlackBerry OS, Blackberry 10, and Palm OS, WebOS operating systems.

Applications 1224 can include any number of different applications installed on computing device 1200. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 1226 manages information received via input components (e.g., display 1210, sensors 1212, and microphone 1216) and information to be outputted via output components (e.g., display 1210 and speaker 1214). Communication module 1228 facilitates communication with other devices via communication system 1218 and includes various software components for handling data received from communication system 1218.

One of ordinary skill in the art will realize that the architecture shown in FIG. 12 is only an example architecture of computing device 1200, and that computing device 1200 may have additional or fewer components than shown, or a different configuration of components. The various components shown in FIG. 12 may be implemented in hardware, software, firmware, or any combination thereof, including one or more signal processing and/or application specific integrated circuits.

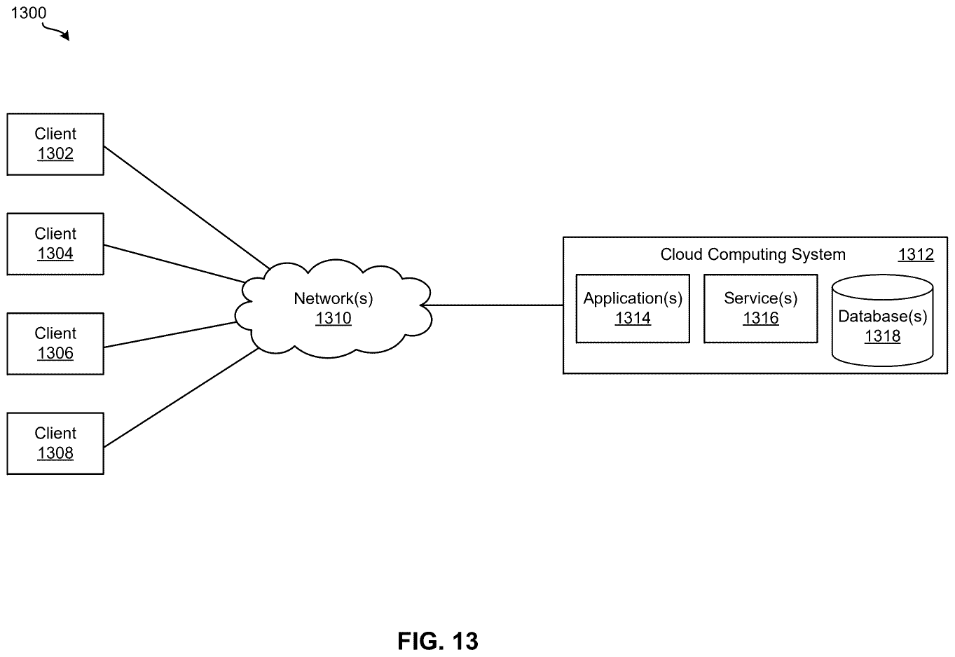

FIG. 13 illustrates an exemplary system 1300 for implementing various embodiments described above. For example, any client devices 1302, 1304, 1306, and 1308 may be used to implement the cloud computing system 1312. As shown, system 1300 includes client devices 1302, 1304, 1306, and 1308, one or more networks 1310, and cloud computing system 1312. Cloud computing system 1312 is configured to provide resources and data to client devices 1302, 1304, 1306, and 1308 via networks 1310. In some embodiments, cloud computing system 1312 provides resources to any number of different users (e.g., customers, tenants, organizations, etc.). Cloud computing system 1312 may be implemented by one or more computer systems (e.g., servers), virtual machines operating on a computer system, or a combination thereof.

As shown, cloud computing system 1312 includes one or more applications 1314, one or more services 1316, and one or more databases 1318. Cloud computing system 1312 may provide applications 1314, services 1316, and databases 1318 to any number of different customers in a self-service, subscription-based, elastically scalable, reliable, highly available, and secure manner.

In some embodiments, cloud computing system 1312 may be adapted to automatically provision, manage, and track a customer's subscriptions to services offered by cloud computing system 1312. Cloud computing system 1312 may provide cloud services via different deployment models. For example, cloud services may be provided under a public cloud model in which cloud computing system 1312 is owned by an organization selling cloud services and the cloud services are made available to the general public or different industry enterprises. As another example, cloud services may be provided under a private cloud model in which cloud computing system 1312 is operated solely for a single organization and may provide cloud services for one or more entities within the organization. The cloud services may also be provided under a community cloud model in which cloud computing system 1312 and the cloud services provided by cloud computing system 1312 are shared by several organizations in a related community. The cloud services may also be provided under a hybrid cloud model, which is a combination of two or more of the aforementioned different models.

In some instances, any one of applications 1314, services 1316, and databases 1318 made available to client devices 1302, 1304, 1306, and 1308 via networks 1310 from cloud computing system 1312 is referred to as a “cloud service.” Typically, servers and systems that make up cloud computing system 1312 are different from the on-premises servers and systems of a customer. For example, cloud computing system 1312 may host an application and a user of one of client devices 1302, 1304, 1306, and 1308 may order and use the application via networks 1310.

Applications 1314 may include software applications that are configured to execute on cloud computing system 1312 (e.g., a computer system or a virtual machine operating on a computer system) and be accessed, controlled, managed, etc. via client devices 1302, 1304, 1306, and 1308. In some embodiments, applications 1314 may include server applications and/or mid-tier applications (e.g., HTTP (hypertext transfer protocol) server applications, FTP (file transfer protocol) server applications, CGI (common gateway interface) server applications, JAVA server applications, etc.). Services 1316 are software components, modules, applications, etc. that are configured to execute on cloud computing system 1312 and provide functionalities to client devices 1302, 1304, 1306, and 1308 via networks 1310. Services 1316 may be web-based services or on-demand cloud services.

Databases 1318 are configured to store and/or manage data that is accessed by applications 1314, services 1316, and/or client devices 1302, 1304, 1306, and 1308. For instance, the customer sales data may be stored in databases 1318. Databases 1318 may reside on a non-transitory storage medium local to (and/or resident in) cloud computing system 1312, in a storage-area network (SAN), on a non-transitory storage medium local located remotely from cloud computing system 1312. In some embodiments, databases 1318 may include relational databases that are managed by a relational database management system (RDBMS). Databases 1318 may be a column-oriented databases, row-oriented databases, or a combination thereof. In some embodiments, some or all of databases 1318 are in-memory databases. That is, in some such embodiments, data for databases 1318 are stored and managed in memory (e.g., random access memory (RAM)).

Client devices 1302, 1304, 1306, and 1308 are configured to execute and operate a client application (e.g., a web browser, a proprietary client application, etc.) that communicates with applications 1314, services 1316, and/or databases 1318 via networks 1310. This way, client devices 1302, 1304, 1306, and 1308 may access the various functionalities provided by applications 1314, services 1316, and databases 1318 while applications 1314, services 1316, and databases 1318 are operating (e.g., hosted) on cloud computing system 1312. Although system 1300 is shown with four client devices, any number of client devices may be supported.

Networks 1310 may be any type of network configured to facilitate data communications among client devices (e.g., first client device 1302, second client device 1304, third client device 1306, and fourth client device 1308) and cloud computing system 1312 using any of a variety of network protocols. Networks 1310 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments and are presented to illustrate the flexibility and advantages of various embodiments of the present disclosure as defined by the following claims. Based on the above disclosure and the following claims, other arrangements, embodiments, implementations, and equivalents will be evident to those skilled in the art and may be employed without departing from the spirit and scope of the present disclosure as defined by the claims.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or” unless explicitly stated otherwise (e.g., if used in combination with “either” or “only one of”).

What is claimed is:

1. A computer implemented method comprising:
accessing a view definition for each entity type in a data file;
accessing a view schema file associated with the accessed view definition;
receiving a first input prompt to modify a structure of the data file;
creating a method request to a generative pre-trained transformer to construct artificial function calls using the first input prompt and one or more schema definitions from the view schema file;
transmitting the method request to the generative pre-trained transformer;
receiving the artificial function calls from the generative pre-trained transformer to modify the data file;
displaying a plain language description of the artificial function calls;
receiving a second input confirming modifications of the structure of the data file according to the plain language description of the artificial function calls;
modifying the structure of the data file using the artificial function calls;
generating code for an application using one or more templates, the one or more templates using the modified data file, wherein the generated code comprises content hashes; and
storing the generated code for the application.

2. The computer implemented method of claim 1, wherein the view definition comprises a list view.

3. The computer implemented method of claim 1, wherein the view definition comprises a details view.

4. The computer implemented method of claim 1, wherein the data file comprises an extensible markup language file.

5. The computer implemented method of claim 1, wherein the data file comprises structures and objects in JavaScript Object Notation (JSON) format.

6. The computer implemented method of claim 1, further comprising displaying details for the artificial function calls.

7. The computer implemented method of claim 1, wherein the first input prompt is received via a chat function.

8. A non-transitory computer-readable medium storing a set of instructions, the set of instructions comprising:
one or more instructions that, when executed by one or more processors of a device, cause the device to perform operations comprising:
accessing a view definition for each entity type in a data file;
accessing a view schema file associated with the accessed view definition;
receiving a first input prompt to modify a structure of the data file;
creating a method request to a generative pre-trained transformer to construct artificial function calls using the first input prompt and one or more schema definitions from the view schema file;
transmitting the method request to the generative pre-trained transformer;
receiving the artificial function calls from the generative pre-trained transformer to modify the data file;
displaying a plain language description of the artificial function calls;
receiving a second input confirming modifications of the structure of the data file according to the plain language description of the artificial function calls;
modifying the structure of the data file using the artificial function calls;
generating code for an application using one or more templates, the one or more templates using the modified data file, wherein the generated code comprises content hashes; and
storing the generated code for the application.

9. The non-transitory computer-readable medium of claim 8, wherein the view definition comprises a list view.

10. The non-transitory computer-readable medium of claim 8, wherein the view definition comprises a details view.

11. The non-transitory computer-readable medium of claim 8, wherein the data file comprises an extensible markup language file.

12. The non-transitory computer-readable medium of claim 8, wherein the data file comprises structures and objects in JavaScript Object Notation (JSON) format.

13. The non-transitory computer-readable medium of claim 8, further comprising displaying details for the artificial function calls.

14. The non-transitory computer-readable medium of claim 8, wherein the first input prompt is received via a chat function.

15. A system comprising:
one or more processors configured to access instructions stored in a memory, the instructions performing operations comprising:
accessing a view definition for each entity type in a data file;
accessing a view schema file associated with the accessed view definition;
receiving a first input prompt to modify a structure of the data file;
creating a method request to a generative pre-trained transformer to construct artificial function calls using the first input prompt and one or more schema definitions from the view schema file;
transmitting the method request to the generative pre-trained transformer;
receiving the artificial function calls from the generative pre-trained transformer to modify the data file;
displaying a plain language description of the artificial function calls;
receiving a second input confirming modifications of the structure of the data file according to the plain language description of the artificial function calls;
modifying the structure of the data file using the artificial function calls;
generating code for an application using one or more templates, the one or more templates using the modified data file, wherein the generated code comprises content hashes; and
storing the generated code for the application.

16. The system of claim 15, wherein the view definition comprises a list view.

17. The system of claim 15, wherein the view definition comprises a details view.

18. The system of claim 15, wherein the data file comprises an extensible markup language file.

19. The system of claim 15, wherein the data file comprises structures and objects in JavaScript Object Notation (JSON) format.

20. The system of claim 15, further comprising displaying details for the artificial function calls.
